(19) United States
(12) Patent Application Publication
(10) Pub. No.: US 2016/0055077 A1
(43) Pub. Date: Feb. 25, 2016

(54) METHOD, DEVICE, AND PROGRAM STORAGE DEVICE FOR AUTONOMOUS SOFTWARE PRODUCT TESTING

(71) Applicant: General Electric Company, Schenectady, NY (US)

(72) Inventors: Ghulam Ali Baloch, Albany, NY (US); Bradford Wayne Miller, Malta, NY (US); Chung Hee Hwang, Malta, NY (US)

(21) Appl. No.: 14/468,040

(22) Filed: Aug. 25, 2014

(51) Int. Cl. G06F 11/36

(52) U.S. Cl. CPC G06F 11/3684; G06F 11/3688; G06F 11/3692

(57) ABSTRACT

A method of testing a software product is performed. The software product is downloaded to a sandbox located on a device, the sandbox constructed so that actions taken by software inside the sandbox do not affect operations of modules on the device located outside of the sandbox. Information about the software product is obtained. Then one or more test libraries are automatically generated, based on the information, each of the test libraries containing one or more executable functions to test the software product. Then the software product is tested in the sandbox using the one or more test libraries and test data, producing test results, wherein the testing includes obtaining information from one or more components of the device outside of the sandbox. Based at least on the test results, it is determined that the software product should be installed fully on the device.

### TECHNICAL FIELD

This application relates generally to software development and testing. More particularly, this application relates to an agent for autonomous software product testing.

### BACKGROUND

Software life cycle management refers to the governance, development, and maintenance of computer software. Specifically, it typically encompasses requirements management, software architecture, computer programming, software testing, software management, change management, product management, and release management. The “life cycle” referred to involves the complete life of a software product, from design stages to distribution and release to maintenance.

While certain aspects of software life cycle management have been automated, it is still a largely manual process. For example, when testing computer software, a developer may utilize testing tools to help create test scenarios for the software, but the decisions as to which environments and configurations/settings to test are determined by a human. Furthermore, testing typically is performed on a device other than the device on which the end user will ultimately run the software product. While developers and testers can attempt to model the operation of an end user device, it still typically falls short with regard to some aspect of the device, whether it is the device itself, the other software installed on the device, personalized settings of the user, or other contextual elements.

### BRIEF DESCRIPTION OF DRAWINGS

The present disclosure is illustrated by way of example and not limitation in the figures of the accompanying drawings, in which like references indicate similar elements and in which:

FIG. 1 is a block diagram illustrating a system in accordance with an example embodiment.

FIG. 2 is a block diagram illustrating a system, in accordance with an example embodiment, for performing software testing.

FIG. 3 is a flow diagram illustrating a method, in accordance with an example embodiment, for testing a software product.

FIG. 4 is a flow diagram illustrating a method, in accordance with an example embodiment, for testing a software product in a sandbox.

FIG. 5 is a flow diagram illustrating a method, in accordance with an example embodiment, for determining whether it is a good time to install a software product.

FIG. 6 is a sequence diagram illustrating a method, in accordance with an example embodiment, for searching for and installing a software product on a device in accordance with an example embodiment.

FIG. 7 is a block diagram illustrating a mobile device, according to an example embodiment.

FIG. 8 is a block diagram of a machine in the example form of a computer system within which instructions may be executed to cause the machine to perform any one or more of the methodologies discussed herein.

### DETAILED DESCRIPTION

### Overview

The description that follows includes illustrative systems, methods, techniques, instruction sequences, and machine-readable media (e.g., computing machine program products) that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

In an example embodiment, an autonomous software product testing agent is provided with the technical effect of enabling the self-testing of a software product on a device that ultimately will install the software product if the testing is successful. The software product may be temporarily installed in a sandbox on the device and tested there. A sandbox is a testing environment that isolates untested code changes and experimentation from a production environment or repository. Sandboxes typically replicate at least the minimal functionality needed to accurately test the programs or other code under development (e.g., usage of the same environment variables as, or access to an identical database to be used by, the stable prior implementation intended to be modified). The testing agent is able to automatically generate and/or select test cases/data and/or test libraries and then test the software product in the sandbox utilizing these test cases/data and/or test libraries. Results can be generated by the testing agent and sent to a software life cycle management agent, which can then automatically decide whether or not to complete the installation of the software product on the device (i.e., outside the sandbox).

Traditionally software life cycle management is performed by a human user manually downloading software, installing it on a device (either a target device or a replica device), testing the software and then pushing the software to target devices. This approach is time consuming, error prone, and costly. In an example embodiment, an autonomous software life cycle management agent in conjunction with a software testing agent described herein reduces these drawbacks. It is able to perform its functions with limited or no human supervision, which avoids human errors, reduces the costs associated with utilizing human resources, and eliminates infrastructure needed to log information of all the assets. In another example embodiment, there are also minimal disruptions to the device/user operations, and new software is tested on the actual device it is intended for and not a replica device. Additionally, software is tested in an isolated environment, so if errors are encountered, there is no need to perform any rollbacks.

In an example embodiment, a technical effect is that the autonomous software life cycle agent is able to make a decision as to whether to install a software product using test results provided by a software testing agent. This decision may be based on many other factors as well, including, for example, upgraded features, service provider credibility, resources needed to run the software product, and cost.

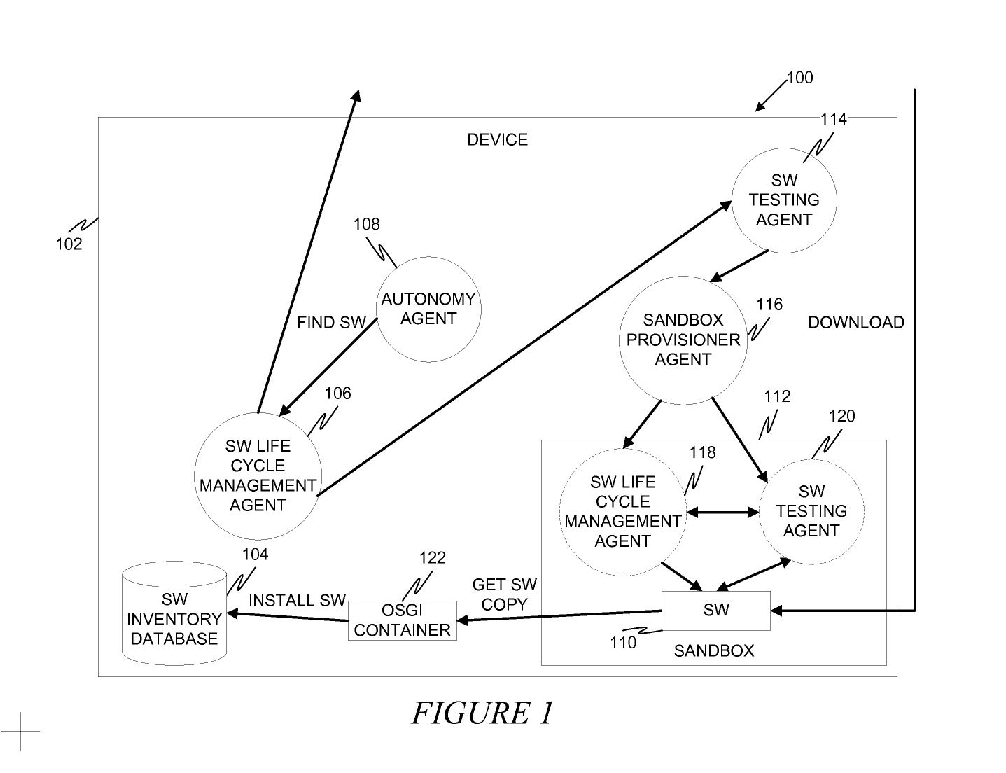

FIG. 1 is a block diagram illustrating a system 100 in accordance with an example embodiment. The system 100 includes a device 102 on which a software product may be executed. The device 102 may include a software inventory database 104 where one or more software product installed on the device 102 may be stored. A software life cycle management agent 106 may act to locate appropriate software for download, testing, and possible installation on the device 102. An autonomy agent 108 may act as a manager in the device 102 to define and execute various goals for the device 102.

Based on instructions from the autonomy agent 108, the software life cycle management agent 106 may act to locate appropriate software products to download

In an example embodiment, communication between the software life cycle management agent 106 and a device community may be performed via the Message Transport Service (MTS). MTS may provide a protocol that allows software product capabilities and/or device requirements to be described semantically. This means that, for example, a list of the capabilities and/or device requirements is encoded in a description language that defines the capabilities semantically. For example, if a desired capability is the ability to edit text on a computer display, this characteristic may be defined by the description language as a possible value for a capability or requirement description, which in logic would associate a value with a particular semantic expression. The communication itself may take a number of forms.

It should be noted that the selected software product to install may be an updated version of a software product already running on the device 102. In other instances, however, the software product to install may be completely new to the device 102 or one previously used but not currently installed.

Once the software product is selected by the software life cycle management agent 106, it may be downloaded and the software product stored in a sandbox 110 on the device 102. Execution of the software product in the sandbox 110 allows it to be tested on the device 102 without causing any runtime or other issues or errors in the device 102. While execution of the software product and any effects from the execution take place in the sandbox 110, the testing itself may include obtaining information from one or more components (hardware and/or software) outside of the sandbox 110. For example, the testing may include obtaining configuration settings for the device 102 from outside of the sandbox 110, but a crash that occurs during testing will not affect settings outside of the sandbox 110. Modifications to files may happen to cloned copies inside the sandbox which appear to the sandboxed software as the actual files.

The software life cycle management agent 106 may instruct a software testing agent 114 to test the software. The software testing agent 114 may then call a sandbox provisioner agent 116, which may clone the software life cycle management agent 106 and place the cloned copy 118 in the sandbox 110. The sandbox provisioner agent 116 may also clone the software testing agent 114 and place the cloned copy 120 in the sandbox 110. The testing may be performed by the cloned copy 120 of the software testing agent 114, and results reported to the cloned copy 118 of the software life cycle management agent 106. The cloned copy 118 of the software life cycle management agent 106 may then make a determination as to whether or not to complete installation of the software product on the device 102. Completing installation typically involves installing the software product in an area outside of the sandbox 110. However, the software product may be run in the sandbox for an extended period (or indefinitely) to verify long-term integrity while the device could still possibly use the results of any contained algorithm.

In an example embodiment, installation and use of the software product/version may be performed using an Open Service Gateway Initiative (OSGi) container 122. OSGI is a specification that describes a modular system and service platform for the Java description language that implements a dynamic component mode. Applications or components, in the form of bundles for deployment, can be remotely installed, started, stopped, updated, and uninstalled without requiring a reboot. The OSGi container 122 for a software product can describe all that is needed in order to successfully install the software product. Thus, if the cloned copy 118 of the software life cycle management agent 106 determines that installation should be completed, a copy of the software product is placed into an OSGi container 122, which is then installed in the software inventory database 104.

In an example embodiment, the architecture described above is implemented on top of a Java Agent Development Framework (JADE). Additionally, an agent communication language (ACL) may be provided to enable the communications between the various agents, including the software life cycle management agent 106, autonomy agent 108, software testing agent 114, and sandbox provisioner agent 116.

It should be noted that the software life cycle management agent 106 and autonomy agent 108 work together to operate the various functions of coordinating the determination to search/subscribe to new software products and/or versions, coordinate the testing of the new software products and/or versions, and decide ultimately which software products and/or version be installed on the device 102. In various example embodiments, the precise functionality performed by each of the software life cycle management agent 106 and autonomy agent 108 may differ, and nothing in this disclosure shall be interpreted as limiting the functionality to only being performed by one or the other.

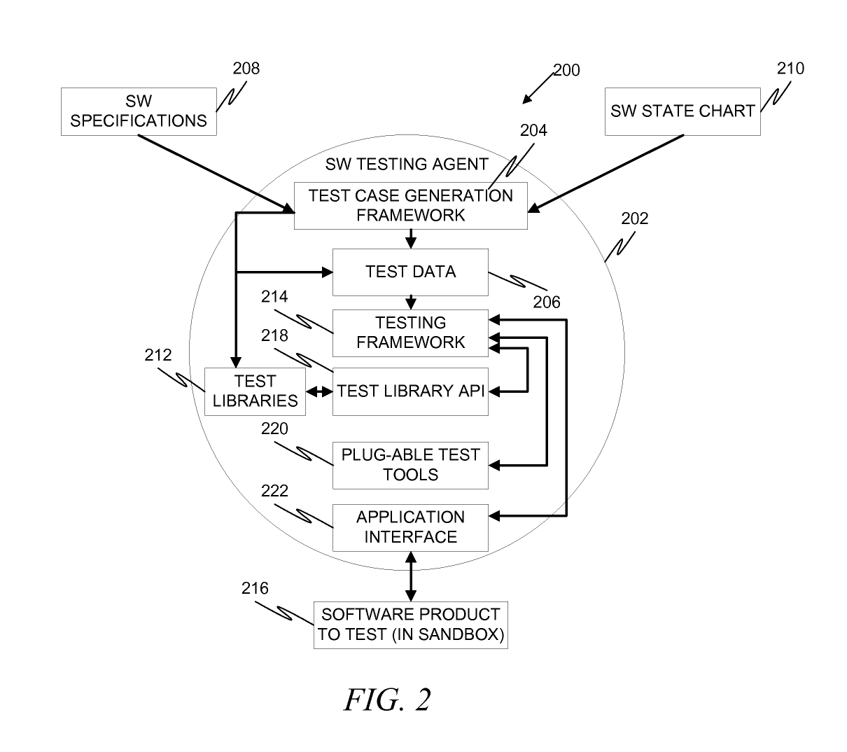

FIG. 2 is a block diagram illustrating a system 200, in accordance with an example embodiment, for performing software testing. The system 200 may include a software testing agent 202. In an example embodiment, the software testing agent 202 represents a more detailed view of the software testing agent 114 of FIG. 1. The software testing agent 202 may include a test case generation framework 204. The test case generation framework 204 may generate test data 206 for the software based, at least partially, on software specifications 208 and/or a software state chart 210. The software specifications 208 for a software product may, for example, be attached as metadata to the software product when downloaded, or may be obtained from another source. The software state chart 210 may provide a description of behavior of the software product when run, including, for example, an indication of the various possible states of the software product and links between those states.

The test case generation framework 204 may also generate one or more test libraries 212. A testing framework 214 may act to test a software product 216 using the test data 206 and test libraries 212. The test libraries 212 may be accessed via a test library application program interface (API) 218. The testing framework 214 may utilize plug-able test tools 220 in this process, and interact with the software product 216 via an application interface 222.

In an example embodiment, once the software life cycle management agent (e.g., software life cycle management agent 106 of FIG. 1) decides that the software product should be installed (e.g., it has passed the testing and any other criteria the software life cycle management agent applies to the decision), then it may wait to install the software fully until it is a good time to do so. This determination may be based on a number of different factors. In one example embodiment, these factors may include the current processing load on one or more processors of the device, current memory utilization, and/or current load on any other system resources of the device. In another example embodiment, additional analysis of past usage may help make certain predictions of future use of the device, which may influence whether or not now is a good time to install the software products. For example, it may be 3:55 pm now and system resources may be available to install the software products now, but the system may learn through analysis of past usage that the user typically runs a system resource heavy process from 4 pm-5 pm every day, and thus the system may determine that now would not be a good time to install the one or more software products. The system may also take into account predicted time to install the one or more software products, and the resources such installation are likely to tie up during the installation process in this analysis.

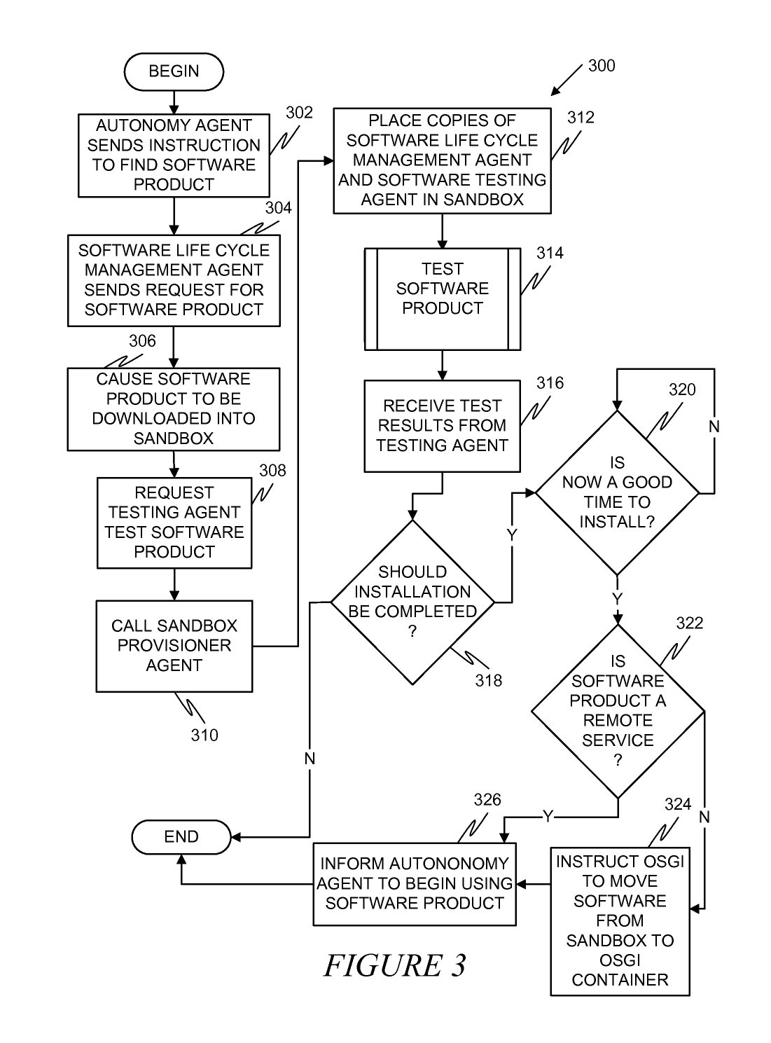

FIG. 3 is a flow diagram illustrating a method 300, in accordance with an example embodiment, for testing a software product. At operation 302, an autonomy agent (e.g., autonomy agent 108 of FIG. 1) may send an instruction to a software life cycle management agent (e.g., software life cycle management agent 106) to find a software product. In an example embodiment, a list of needed capabilities of the device (e.g., device 102) is prepared. In an example embodiment, this list may be prepared by an autonomy agent operating on the device. The autonomy agent may perform an analysis of the device including, for example, hardware capabilities of the device, operating system installed on the device, additional software installed on the device, settings configured by a user of the device, etc. The autonomy agent may also take into account additional factors such as specified desires by a user or users of the device (e.g., indicating a desire to obtain a word processing program) as well as various dynamically determined characteristics such as device location, environmental factors, other devices to which the device communicates, and any other factor that might affect a decision as to which type of software product would be appropriate for the device.

At operation 304, the software life cycle management agent may send a request from the device for a software product. In an example embodiment, the request may be for a list of software products that meet the needed capabilities. It should be noted that the software products referred to may include aspects of a software product which may be considered by some to be services, for example, software as a service (SaaS)-type software where only a small portion of code is downloaded and installed on the device, with the bulk of the software functionality residing on external servers communicated to by the device, or may include more traditional software that is fully installed on the device itself prior to running. The request may include the list of needed capabilities prepared in operation 302. This list may be stored in accordance with, for example, a semantic language.

Once an appropriate software product is located, then at operation 306 the software life cycle management agent may cause the software product to be downloaded into a sandbox (e.g., sandbox 110) on the device. At operation 308, the software life cycle management agent may instruct a software testing agent (e.g., software testing agent 114) to test the software in the sandbox. At operation 310, the software testing agent may call a sandbox provisioner agent (e.g., sandbox provisioner agent 116), which, at operation 312, may place copies of the software life cycle management agent and the software testing agent in the sandbox. At operation 314, the copy (e.g., copy 120) of the software testing agent in the sandbox may test the software. At operation 316, the software testing agent may report the results of the testing to the copy (e.g., copy 118) of the software life cycle management agent in the sandbox.

At operation 318, the test results may be utilized to determine whether to complete installation of the selected software product. This determination may be performed in a number of different ways. In one example embodiment, the test results include a binary determination of whether the software product “passed” or “failed” the testing. In such a case, this operation may involve accepting this binary determination and acting accordingly. In another example embodiment, a more detailed analysis may be determined based on the results of the testing. For example, the testing may produce a report that includes an indication of how various system resources were utilized during the testing, and the software life cycle management agent or autonomy agent may determine, based on this information and preset thresholds, whether or not the software should be installed. Additionally, performance information from the testing may also be included in this determination. For example, the software life cycle management agent or autonomy agent may allow a certain level of system resources to be utilized if particular performance thresholds are met, but not allow that level of system resource to be utilized if the performance thresholds are not met. Additionally, factors such as cost may be utilized in this determination as well. For example, the software life cycle management agent or autonomy agent may accept a certain performance level and a certain amount of system resources utilized if the cost of the software product is low, but may not accept them if the cost of the software product is high. Additionally, other factors such as the trust level of the software provider may be utilized in this determination.

If it is determined at operation 318 that installation of the tested software product should not be completed, then the process may end. Otherwise, at operation 320, it is determined if now is a good time to install the software product. If not, then the process may continue to loop back to operation 320 until now is a good time to install the software product. Once it is determined that it is a good time to install the software product, at operation 322, it is determined if the software product is a remote service. If not, then at operation 324 OSGi may be instructed to move the software from the sandbox to an OSGi container (e.g., container 122) from which installation can be completed. Then at operation 326 the autonomy agent can be informed to begin using the software and store information about the software in a software inventory database (e.g., database 104). If at operation 322 it is determined that the software product is a remote service, then operation 324 may be skipped and the process may move directly to operation 326.

As described earlier, one of the factors that may be considered by the system in operation 318 is the level of trust of the service provider distributing the software product. There are a number of different mechanisms by which a system can determine a level of trust. Information relevant to a trust determination can come from a number of different sources, such as direct interaction (one's own experience working with the service provider), direct observation (acting as a third party and observing behavior of the service provider with others), witness information (reports from others on their interactions), sociological information (based on the role the service provider plays in society and judging behavior based on that rather than specific interaction), and prejudice (the assignment of a property to an individual based on some specific feature that allows it to be considered as part of a group that has the property). One characteristic that might be of concern is whether the service provider leaks information learned from the deployment of the software product on a device to users or entities not in control of the device. This is of particular concern with regards to so-called “spyware” which is software that may be installed intentionally by a user without the user realizing that it gathers and leaks information about the user and/or user's device.

One mechanism to detect such leaks is running the software product in a sandbox on the device and performing tests specifically to detect leaks. This activity could be expanded to include artificial compatriots to test the fidelity of the software product with respect to contractually agreed limits on retention or use of information. However, this solution may not detect a condition where the software product is written to behave normally until or unless a particular (non-present) agent initiates communication to begin the leak process.

One solution would be to run the software product on a known trusted server that has sandboxing capabilities which allow for remote testing and examination of the agent. As such, in an example embodiment, the testing of the software product installed in the sandbox of the device may be expanded to include testing and/or analysis of testing performed on the software product in a sandbox of another device, such as a server (although embodiments are possible where information is obtained from other devices similar to the device in question).

In an example embodiment, trust may be represented using a combined trust model. In a combined trust model, trust characteristics are modeled across multiple dimensions, such as quality, cost, likelihood of success, and timeliness. Trust can be updated based on interactions with the software product and/or service provider, and can also be based on reputation (e.g., the reported trust score from some other agent that has interacted with the software product and/or service provider).

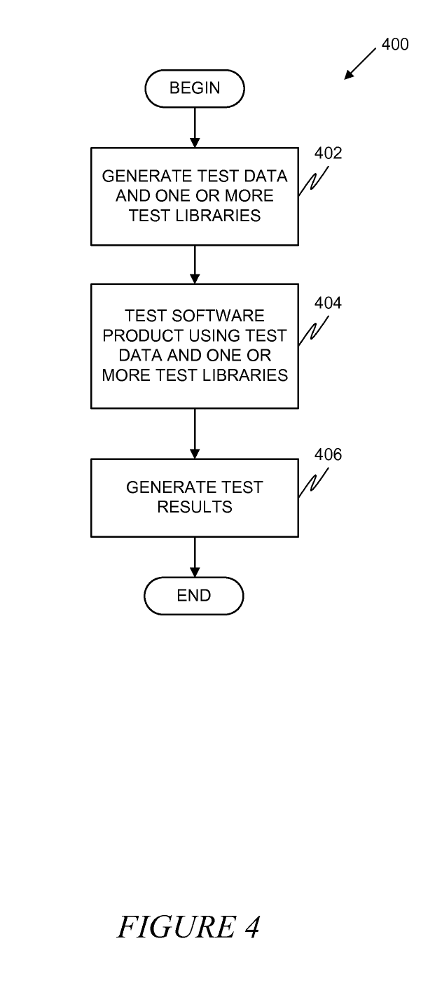

FIG. 4 is a flow diagram illustrating a method 400, in accordance with an example embodiment, for testing a software product in a sandbox. In an example embodiment, this method 400 represents operation 314 of FIG. 3 in more detail. At operation 402, test data and one or more test libraries may be automatically generated. This may be performed by accessing software specifications and/or a software state chart. At operation 404, the software product is tested using the test data and one or more test libraries. At operation 406, test results from the testing may be generated.

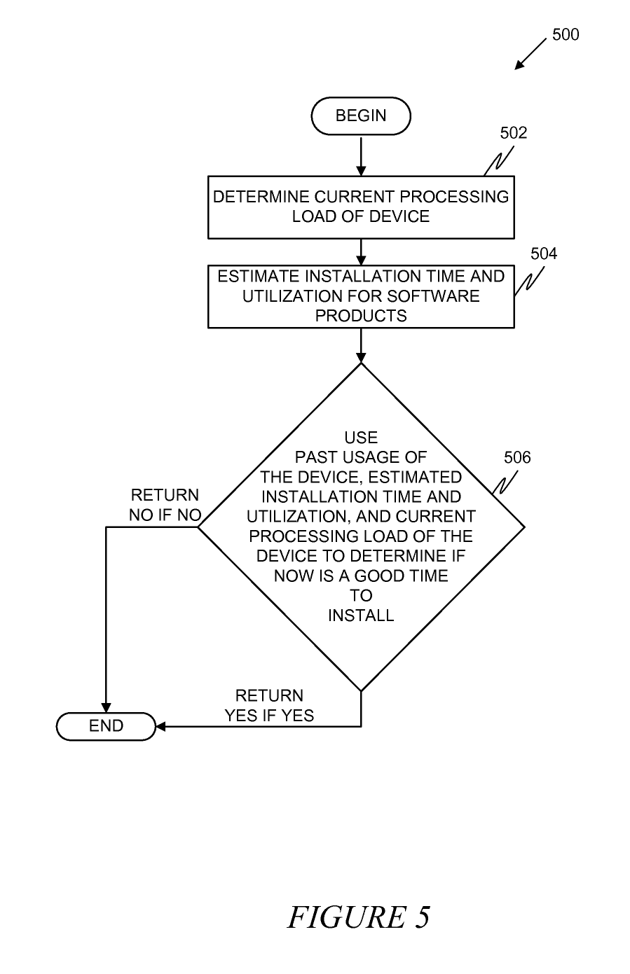

FIG. 5 is a flow diagram illustrating a method 500, in accordance with an example embodiment, for determining whether it is a good time to install a software product. In an example embodiment, this method 500 represents operation 320 of FIG. 3 in more detail. At operation 502, the current processing load of the device is determined. This may include scanning current CPU, GPU, and memory utilization, for example. At operation 504, an estimated installation time and utilization (e.g., how much processing and memory usage is needed for installation) for each of the software products is determined. At operation 506, past usage of the device, the estimated installation time and utilization, and the current processing load of the device is utilized in a determination of whether or not now is a good time to install one or more of the software products. If now is not a good time, then the method 500 ends and a “No” is returned. If now is a good time, then the method 500 ends and a “Yes” is returned.

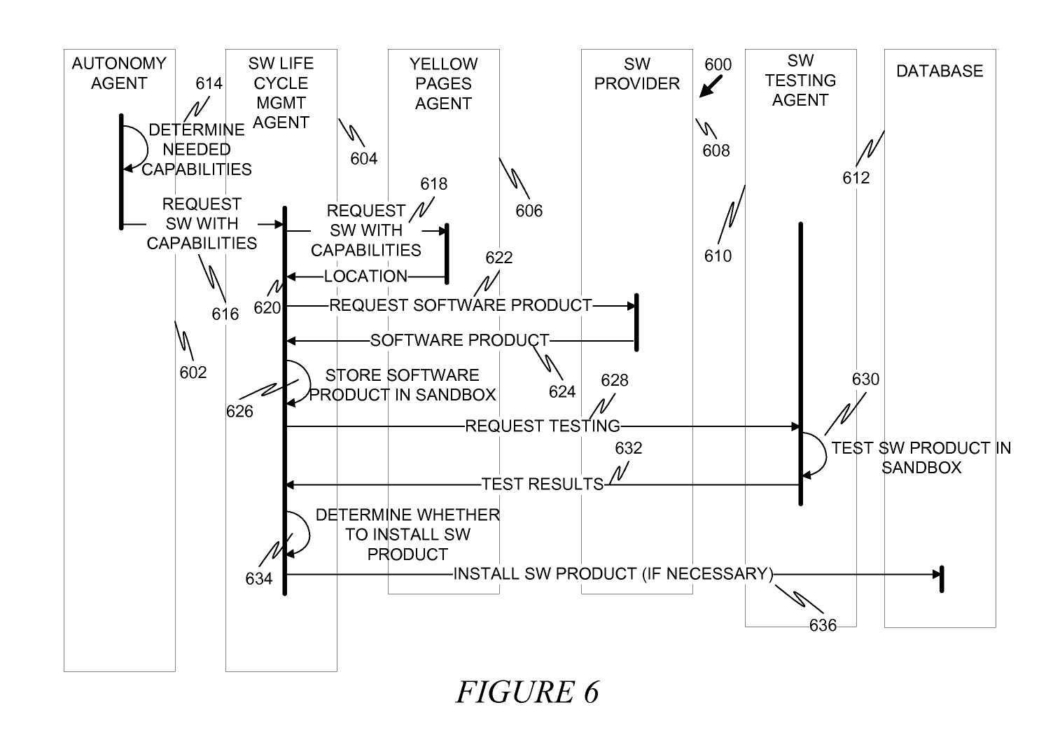

FIG. 6 is a sequence diagram illustrating a method 600, in accordance with an example embodiment, for searching for and installing a software product on a device in accordance with an example embodiment. The method 600 may utilize an autonomy agent 602, software life cycle management agent 604, yellow pages agent 606, software provider 608, software testing agent 610, and database 612. A yellow pages agent is a module or component that provides a database that organizes information (here available software) based on category and/or capability, allowing it to be searched using that criteria. At operation 614, the autonomy agent 602 may determine needed capabilities of a device. At operation 616, the autonomy agent 602 may send a request for software with the capabilities to the software life cycle management agent 604. At operation 618, the software life cycle management agent 604 may request a software product with the capabilities from the yellow pages agent 606. The yellow pages agent 606 may respond with a location at operation 620.

At operation 622, the software life cycle management agent 604 may request the software product from the software provider 608 using the location. At operation 624 the software product is returned. At operation 626, the software life cycle management agent 604 may store the software product in a sandbox. At operation 628, the software life cycle management agent 604 may request testing on the software product by the software testing agent 610. The software testing agent 610 may then test the software product in the sandbox at operation 630, and then return the results at operation 632.

At operation 634, the software life cycle management agent 604 may determine whether to install the software product based, at least partially, on the test results. At operation 636, if the software product is to be installed, the software product is installed to the database 612.

### Example Mobile Device

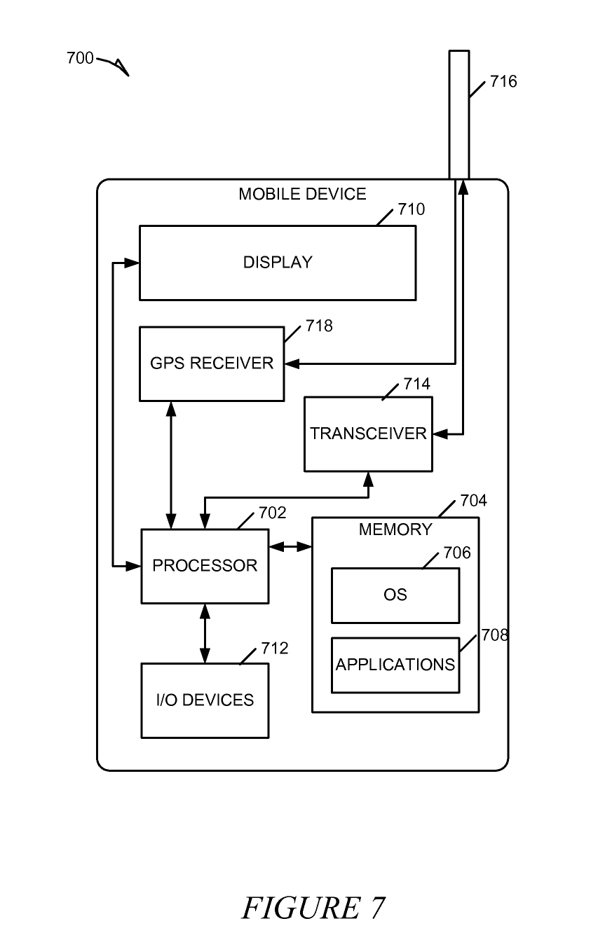

FIG. 7 is a block diagram illustrating a mobile device 700, according to an example embodiment. The mobile device 700 can include a processor 702. The processor 702 can be any of a variety of different types of commercially available processors suitable for mobile devices 700 (for example, an XScale architecture microprocessor, a Microprocessor without Interlocked Pipeline Stages (MIPS) architecture processor, or another type of processor). A memory 704, such as a random access memory (RAM), a Flash memory, or other type of memory, is typically accessible to the processor 702. The memory 704 can be adapted to store an operating system (OS) 706, as well as application programs 708, such as a mobile location enabled application that can provide location based services (LBSs) to a user. The processor 702 can be coupled, either directly or via appropriate intermediary hardware, to a display 710 and to one or more input/output (I/O) devices 712, such as a keypad, a touch panel sensor, a microphone, and the like. Similarly, in some embodiments, the processor 702 can be coupled to a transceiver 714 that interfaces with an antenna 716. The transceiver 714 can be configured to both transmit and receive cellular network signals, wireless data signals, or other types of signals via the antenna 716, depending on the nature of the mobile device 700. Further, in some configurations, a GPS receiver 718 can also make use of the antenna 716 to receive GPS signals.

### Modules, Components and Logic

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is tangible unit capable of performing certain operations and can be configured or arranged in a certain manner. In example embodiments, one or more computer systems (e.g., a standalone, client or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple such hardware-implemented modules exist contemporaneously, communications can be achieved through signal transmission (e.g., over appropriate circuits and buses) that connect the hardware-implemented modules. In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one of processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network (e.g., the Internet) and via one or more appropriate interfaces (e.g., application program interfaces (APIs).)

### Electronic Apparatus and System

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of description language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., a FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

### Example Machine Architecture and Machine-Readable Medium

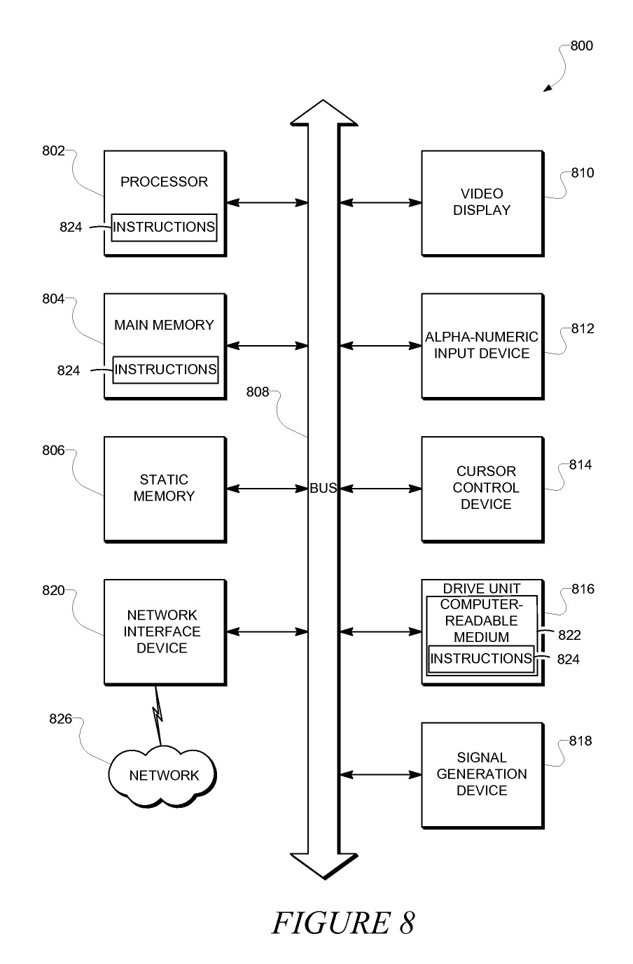

FIG. 8 is a block diagram of a machine in the example form of a computer system 800 within which instructions 824 may be executed to cause the machine to perform any one or more of the methodologies discussed herein. In alternative embodiments, the machine operates as a standalone device or can be connected (e.g., networked) to other machines. In a networked deployment, the machine can operate in the capacity of a server or a client machine in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804 and a static memory 806, which communicate with each other via a bus 808. The computer system 800 can further include a video display unit 810 (e.g., a liquid crystal display (LCD) or a cathode ray tube (CRT)). The computer system 800 also includes an alpha-numeric input device 812 (e.g., a keyboard or a touch-sensitive display screen), a user interface (UI) navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 can also reside, completely or at least partially, within the main memory 804 and/or within the processor 802 during execution thereof by the computer system 800, with the main memory 804 and the processor 802 also constituting machine-readable media 822.

While the machine-readable medium 822 is shown in an example embodiment to be a single medium, the term “machine-readable medium” can include a single medium or multiple media (e.g., a centralized or distributed database, and/or associated caches and servers) that store the one or more instructions 824 or data structures. The term “machine-readable medium” shall also be taken to include any tangible medium that is capable of storing, encoding or carrying instructions 824 for execution by the machine and that cause the machine to perform any one or more of the methodologies of the present disclosure, or that is capable of storing, encoding or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 can be transmitted or received over a communications network 826 using a transmission medium. The instructions 824 can be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes can be made to these embodiments without departing from the broader spirit and scope of the disclosure. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

This written description uses examples to disclose the inventive subject matter, including the best mode, and also to enable any person skilled in the art to practice the inventive subject matter, including making and using any devices or systems and performing any incorporated methods. The patentable scope of the inventive subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of testing a software product, the method comprising:
downloading the software product to a sandbox located on a device, the sandbox constructed so that actions taken by software inside the sandbox do not affect operations of modules on the device located outside of the sandbox and appear to the software product to be performed by the device;
obtaining software specifications for the software product;
analyzing the software product to generate a software state chart indicating various possible states of the software product and links between those states;
automatically generating, using the software specifications and the software state chart, one or more test libraries, each of the test libraries containing one or more executable functions to test the software product;
automatically generating, using the software specifications and the software state chart, test data for the software product;
testing the software product in the sandbox by accessing the one or more test libraries via a test library application program interface (API) and executing the one or more executable functions contained in the one or more test libraries using the test data as input, to produce test results, wherein the testing includes obtaining configuration information about the device without altering the configuration information;
based at least on the test results, automatically determining that the software product should be installed fully on the device; and
installing, from the sandbox, the software product on the device in an area outside of the sandbox without redownloading the software product.

2. The method of claim 1, wherein the software specifications are attached as metadata to the software product when downloaded.

3. (canceled)

4. (canceled)

5. The method of claim 1, wherein the determining that the software product should be installed fully on the device is at least partially based on whether performance results from the testing meet or exceed one or more thresholds.

6. The method of claim 1, wherein the determining that the software product should be installed fully on the device is at least partially based on cost of the software product.

7. The method of claim 1, further comprising, in response to a determination that the software product should be installed fully on the device, determining whether to install the software product fully on the device immediately or to delay installation, based on current processing load and memory usage of the device.

8. The method of claim 7, wherein the determining to install the software product fully on the device immediately includes examining an estimated time it will take to install the software product fully on the device.

9. The method of claim 8, wherein the determining to install the software product fully on the device immediately is further based on scheduled processing load and memory usage for the device.

10. A device comprising:
a software inventory database;
a sandbox, the sandbox constructed so that actions taken by software inside the sandbox do not affect operations of modules on the device located outside of the sandbox and appear to the software product to be performed by the device;
a software life cycle management agent, comprising one or more processors configured to:
download a software product in the sandbox;
request that a software testing agent test the software, the software testing agent configured to:
obtain software specifications for the software product;
analyze the software product to generate a software state chart indicating various possible states of the software product and links between those states;
automatically generate, using the software specifications and the software state chart, one or more test libraries, each of the test libraries containing one or more executable functions to test the software product;
automatically generate, using the software specifications and the software state chart, test data for the software product;
test the software product in the sandbox by accessing the one or more test libraries via a test library application program interface (API) and executing the one or more executable functions contained in the one or more test libraries using the test data as input, producing test results, wherein the testing includes obtaining information from one or more components of the device outside of the sandbox;
the software life cycle management agent further configured to:
based at least on the test results, automatically determine that the software product should be installed fully on the device; and
install, from the sandbox, the software product on the device in an area outside of the sandbox without redownloading the software product.

11. The device of claim 10, wherein copies of the software life cycle management agent and the software testing agent are stored in the sandbox.

12. A non-transitory machine-readable storage medium comprising instructions, which when implemented by one or more machines, cause the one or more machines to perform operations for testing a software product, the operations comprising:
downloading the software product to a sandbox located on a device, the sandbox constructed so that actions taken by software inside the sandbox do not affect operations of modules on the device located outside of the sandbox and appear to the software product to be performed by the device;
obtaining software specifications for the software product;
analyzing the software product to generate a software state chart indicating various possible states of the software product and links between those states;
automatically generating, using the software specifications and the software state chart, one or more test libraries, each of the test libraries containing one or more executable functions to test the software product;
automatically generating, using the software specifications and the software state chart, test data for the software product;
testing the software product in the sandbox by accessing the one or more test libraries via a test library application program interface (API) and executing the one or more executable functions contained in the one or more test libraries using the test data as input, to produce test results, wherein the testing includes obtaining configuration information about the device without altering the configuration information;
based at least on the test results, automatically determining that the software product should be installed fully on the device; and
installing, from the sandbox, the software product on the device in an area outside of the sandbox without redownloading the software product.

13. The non-transitory machine-readable storage medium of claim 12, wherein the software specifications are attached as metadata to the software product when downloaded.

14. (canceled)

15. (canceled)

16. The non-transitory machine-readable storage medium of claim 12, wherein the determining that the software product should be installed fully on the device is at least partially based on whether performance results from the testing meet or exceed one or more thresholds.

17. The non-transitory machine-readable storage medium of claim 12, wherein the determining that the software product should be installed fully on the device is at least partially based on cost of the software product.

18. The non-transitory machine-readable storage medium of claim 12, wherein the operations further comprise, in response to a determination that the software product should be installed fully on the device, determining whether to install the software product fully on the device immediately or to delay installation, based on current processing load and memory usage of the device.

19. The non-transitory machine-readable storage medium of claim 18, wherein the determining to install the software product fully on the device immediately includes examining an estimated time it will take to install the software product fully on the device.

20. The non-transitory machine-readable storage medium of claim 19, wherein the determining to install the software product fully on the device immediately is further based on scheduled processing load and memory usage for the device.
